(19) United States
(12) Patent Application Publication
(10) Pub. No.: US 2025/0293306 A1
(43) Pub. Date: Sep. 18, 2025

(54) NON-AQUEOUS ELECTROLYTE SOLUTIONS

(71) Applicant: TOYOTA MOTOR ENGINEERING & MANUFACTURING NORTH AMERICA, INC., Plano, TX (US)

(72) Inventors: John G. MULDOON, Saline, MI (US); John B. WAUGH, Ann Arbor, MI (US); Mikhail REDKO, Ann Arbor, MI (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-shi (JP)

(21) Appl. No.: 18/606,055

(22) Filed: Mar. 15, 2024

(51) Int. Cl. H01M 10/0568; H01M 10/052; H01M 10/0569

(52) U.S. Cl. CPC H01M 10/0568; H01M 10/052; H01M 10/0569; H01M 2300/0034; H01M 2300/004

(57) ABSTRACT

Electrolyte compositions for secondary batteries having a metal anode are provided. The compositions include an electrolyte salt of an alkali metal, an alkaline earth metal, zinc, or aluminum; at least one solvent which solubilizes the electrolyte salt; and up to 25 wt. % of a selected non-polar additive. The solvent is selected from cyclic sulfones, cyclic sultones, cyclic ethers, partially fluorinated sulfonamides, fluorinated solvents and glymes. The nonpolar additive is selected from aromatic hydrocarbons, partially fluorinated aromatic hydrocarbons, fluorinated monoethers, partly fluorinated polyethers, fluorinated phosphate esters and fluorinated linear sulfones. Multiple combinations of metal salts, solvents and nonpolar additives having a coulombic efficiency of with respect to plating and stripping of the metal of at least 90% are provided.

### FIELD OF THE INVENTION

This disclosure is directed to novel compositions of non-aqueous electrolytes for metal ion batteries having a high coulombic efficiency with respect to plating and stripping of the metal.

### DESCRIPTION OF THE RELATED ART

The ongoing requirement for high energy rechargeable batteries capable to meet ever-increasing consumer demands for portable electronics, power tools, and electric vehicles (EVs) having batteries of longer charge life and of lower cost continues to drive research and development of next generation rechargeable batteries. Lithium batteries are generally considered the benchmark of present battery technology; however, research and development directed to new technologies having 2-3 times greater energy density is ongoing throughout the industry.

Metal based anodes are receiving much attention as a technology for increasing the energy density of a battery. However, employing metal anodes creates challenges associated with the low negative electrochemical potential of the metal which may lead to reactivity with the electrolyte. This effect is well known for lithium metal anodes but is also a problem that must be addressed for all potential metal anodes. The reduction of the electrolyte on the surface of the metal anode results in the formation of a solid electrolyte interface (SEI). This SEI may be unstable and non-uniform due to rupturing and reformation throughout the reversible plating of the metal during charge and discharge of the battery and metal dendrite growth results. Such growth of the metal dendrite may lead to a rapid and large increase of the surface area of the anode and can result in thermal runaway or shorting of the battery. With each generation of the SEI, additional electrolyte is decomposed via anode metal reduction and as a result the coulombic efficiency (CE) of the deposition and dissolution of the metal is significantly reduced. The coulombic efficiency measures the ratio of the discharge capacity relative to the charge capacity. A low coulombic efficiency, for example 50%, renders half of the deposited metal unrecoverable on each deposition and dissolution cycle and thus, the content of the available electroactive metal on the anode is depleted. In addition, electrolyte is degraded during each regeneration of the SEI and both these factors contribute to the reduction of cycle life of the battery.

Thus, there is a need for CE enhancing electrolyte compositions to improve the performance of lithium metal batteries and to promote the development of other secondary batteries based upon other metals including alkali metals other than lithium, alkaline earth metals, aluminum, and zinc. The primary purpose of CE-enhancing electrolyte compositions including solvents, metal salts and additives is that upon first contact of the anode metal and the electrolyte composition, all components of the electrolyte react with the metal such that the more reactive components react first and are incorporated into the lowest layers of the SEI. Solvents, metal salts, and additives which assist in the formation of SEIs that are uniform, fast metal ion conductors, poor electric conductors and form an elastic or self-healing layer need to be identified and employed. Any characteristic that limits further SEI growth, resists cracking of the SEI due to the expansion and contraction of metal deposition and dissolution and enhances metal ion diffusion contributes to a high CE.

Average CE (also referred to herein simply as “CE”) may be measured as described by Adams et al. (Energy Mater., 2018, 8, 1702097). This reference is directed to lithium anodes; however, the method can be applied to other metals as applied in this disclosure. Initially a large reservoir of metal (QT) is electroplated onto a current collector. Then a smaller amount (QC) of metal is cycled back and forth between the electrodes for ‘n’ cycles as a second step such that metal is plated and stripped from the metal electroplated on the current collector rather than from the original surface of the current collector. And finally, the remaining metal (QS) on the current collector is stripped off in a third step to reveal or provide the capacity of metal that remains such that the average CE can be calculated from the equation:

$$CEavg = ( nQC + QS ) / ( nQC + QT )$$

The present inventors are investigating electrolyte compositions which enhance metal battery performance by having a high CE with the beneficial properties described above. One aspect of this ongoing research is disclosed in U.S. application Ser. No. 17/586,302, filed Jan. 27, 2022, which describes a non-aqueous electrolyte, with a coulombic efficiency with respect to lithium of at least 80%, that includes a Group 1 salt dissolved in a mixture containing two sulfone compounds, a mixture containing a sulfone compound and a sultone compound, and/or a mixture containing a sulfone compound and a sulfonamide compound. The Group 1 salt can be a lithium salt, the sulfone compound can be a cyclic sulfone such as thietane-1,1-dioxide and sulfolane, the sultone compound can be a cyclic sultone such as 1,3-propane sultone, and the sulfonamide compound can be a partially fluorinated sulfonamide such as 1,1,1-trifluoro-N,N-dimethylmethanesulfonamide and N-butyl-1,1,1-trifluoro-N-methylmethanesulfonamide. Additives such as another lithium salt, a polyunsaturated compound, a cyclic anhydride, a cyclic unsaturated sultone, and/or a cyclic phosphate can be included in the non-aqueous electrolyte.

However, there is a need to identify a broader range of electrolyte compositions having high CE performance for secondary batteries based on lithium metal and based on other metals including other alkali metals, alkaline earth metals, zinc, and aluminum.

### SUMMARY OF THE INVENTION

Accordingly, an object of this application is to provide electrolyte compositions having high coulombic efficiency for metal ion batteries based upon metal anodes including anodes of alkali metals, alkaline earth metals, zinc, and aluminum.

These and other objects are provided by the embodiments of the present application, the first embodiment of which includes a metal ion electrolyte composition, comprising:

at least one electrolyte salt of an alkali metal, an alkaline earth metal, zinc, and aluminum;

at least one solvent which solubilizes the at least one electrolyte salt; and

up to 25 wt. % of at least one non-polar additive; wherein

the at least one solvent which solubilizes the at least one electrolyte salt is selected from the group consisting of cyclic sulfones, cyclic sultones, cyclic ethers, partially fluorinated sulfonamides, fluorinated solvents, and glymes,

the at least one nonpolar additive is selected from the group consisting of aromatic hydrocarbons, partially fluorinated aromatic hydrocarbons, fluorinated monoethers, partly fluorinated polyethers, fluorinated phosphate esters and fluorinated linear sulfones, and

a coulombic efficiency of the electrolyte composition with respect to plating and stripping of the alkali metal, alkaline earth metal, zinc or aluminum is at least 90%.

In one aspect of the first embodiment, the at least one solvent comprises a cyclic sulfone which is selected from the group consisting of thietane-1,1-dioxide, 1,3-propane sultone and sulfolane.

In one aspect of the first embodiment, the at least one solvent comprises a cyclic sulfone and a partially fluorinated sulfonamide.

In one aspect of the first embodiment, the at least one solvent comprises a cyclic sulfone and a fluorinated solvent.

In a second embodiment, the at least one electrolyte salt selected from the group consisting of an alkali metal, an alkaline earth metal, zinc, and aluminum is a salt of an alkali metal.

In an aspect of the second embodiment the alkali metal is lithium and the at least one electrolyte salt is selected from the group consisting of lithium bis(trifluoromethanesulfonyl)imide, lithium bis(fluorosulfonyl)imide, lithium bis(oxalato)borate, lithium hexafluorophosphate, lithium hexafluoroarsenate, lithium tetrafluoroborate, lithium tetracyanoborate, lithium perchlorate, lithium tris((trifluoromethanesulfonyl)methanide, and lithium tetrafluorooxalatophosphate.

In an aspect of the second embodiment, the at least one solvent comprises a cyclic sulfone and a partially fluorinated sulfonamide, a cyclic sulfone and a fluorinated solvent, or a cyclic sulfone and from 2 to 8 fluorinated solvents.

In an aspect of the second embodiment, the at least one electrolyte salt comprises from 2 to 5 electrolyte salts.

In an aspect of the second embodiment, the at least one polar additive is toluene, and a content of the toluene is from 0.15 wt. % to 15 wt. %.

In a third embodiment, the at least one electrolyte salt selected from the group consisting of an alkali metal, an alkaline earth metal, zinc, and aluminum is a salt of an alkaline earth metal.

In an aspect of the third embodiment, the alkaline earth metal is magnesium and the at least one electrolyte salt is selected from the group consisting of [Mg2Cl3-6THF][HMDSAlCl3], Mg[TFSI]2, Mg(ClO4)2, Mg(BPh2Bu)2, Mg(AlCl2BuEt)2, Mg(HMDS)2, Mg(BH4)2, MgB12H12, Mg(CB11H12)2.

In an aspect of the third embodiment, the at least one solvent is selected from the group consisting of cyclic ethers, fluorinated solvents and glymes.

In an aspect of the third embodiment, the at least one nonpolar additive is toluene.

The foregoing description is intended to provide a general introduction and summary of the present disclosure and is not intended to be limiting in its disclosure unless otherwise explicitly stated. The presently preferred embodiments, together with further advantages, will be best understood by reference to the following detailed description taken in conjunction with the accompanying drawings.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows the measurement of the average coulombic efficiency (CE) of stripping and plating lithium metal in the electrolyte: 50% thietane-1,1-dioxide: 50% 1,1,1-trifluoro-N,N-dimethylmethanesulfonamide: 2.5 mmol LiFSI.

FIG. 2 shows the measurement of the average coulombic efficiency (CE) of stripping and plating lithium metal in the electrolyte: 50% thietane-1,1-dioxide: 40% 1,1,1-trifluoro-N,N-dimethylmethanesulfonamide; 10% toluene: 2.5 mmol LiFSI.

FIG. 3 shows the measurement of the average coulombic efficiency (CE) of stripping and plating magnesium metal in the electrolyte: [Mg2Cl3-6THF][HMDSAlCl3] salt (0.25 M) in THF solvent.

FIG. 4 shows the measurement of the average coulombic efficiency (CE) of stripping and plating magnesium metal in the electrolyte: [Mg2Cl3-6THF][HMDSAlCl3] salt (0.25 M) in 90% THF: 10% toluene solvent.

### DETAILED DESCRIPTION OF THE PREFERRED EMBODIMENTS

Referring now to the drawings, wherein like reference numerals designate identical or corresponding parts throughout the several views.

In an ongoing study of non-aqueous electrolyte compositions for metal-ion secondary batteries which have high coulombic efficiency (CE) for stripping and plating of metals at the anode, the present inventors have unexpectedly discovered that the addition of selected non-polar solvents to the electrolyte solvent mixture enhances the CE of the electrolyte. In the preparation of electrolyte compositions many factors such as viscosity, conductivity, metal-ion diffusivity, transference number, safety, etc. must be considered. Small changes in electrolyte composition, for example, salts, solvents, additives, and diluents can significantly affect the resulting properties. In investigation of additives which enhance the tunability and performance of electrolyte compositions for metal-ion batteries, the inventors have identified a group of non-polar solvents, referred to as “tertiary solvents” which when included as a component in small proportion of the composition increase the CE of the electrolyte for the specific metal of the electrolyte salt included. This discovery was initially found for lithium metal anodes, and it has been determined to be applicable to a range of metals including, but not limited to other alkali metals, alkaline earth metals, zinc, and aluminum.

Although this disclosure is not limited according to theory, it is believed that the tertiary solvent does not solvate the metal ion or enhance the solubility of the metal salt in the electrolyte composition. Rather, the tertiary solvent may modify the viscosity of the electrolyte composition and/or promote solvation of the metal ion with the solvent system rather than the associate anion. Tertiary solvents include one or more of aromatic hydrocarbons, partially fluorinated aromatic hydrocarbons, fluorinated monoethers, fluorinated phosphate esters and fluorinated linear sulfones.

For example, it has been found that the average CE of an electrolyte made with a 50:50 combination of thietane-1,1-dioxide (TT): 1,1,1-trifluoro-N,N-dimethylmethanesulfonamide (sulfonamide) and 2.5 mmol LiFSI salt can be improved by introducing small amounts of toluene as a tertiary solvent to the composition. The effect of toluene addition on average coulombic efficiency is shown in Table 1.

TABLE 1

| | |
|---|---|
| Toluene Content | Coulombic Efficiency |

| | | | |
|---|---|---|---|
| Electrolyte 1 | 0 wt. | % | 99% |
| Electrolyte 2 | 5 wt. | % | 99.2% |
| Electrolyte 3 | 10 wt. | % | 99.5% |

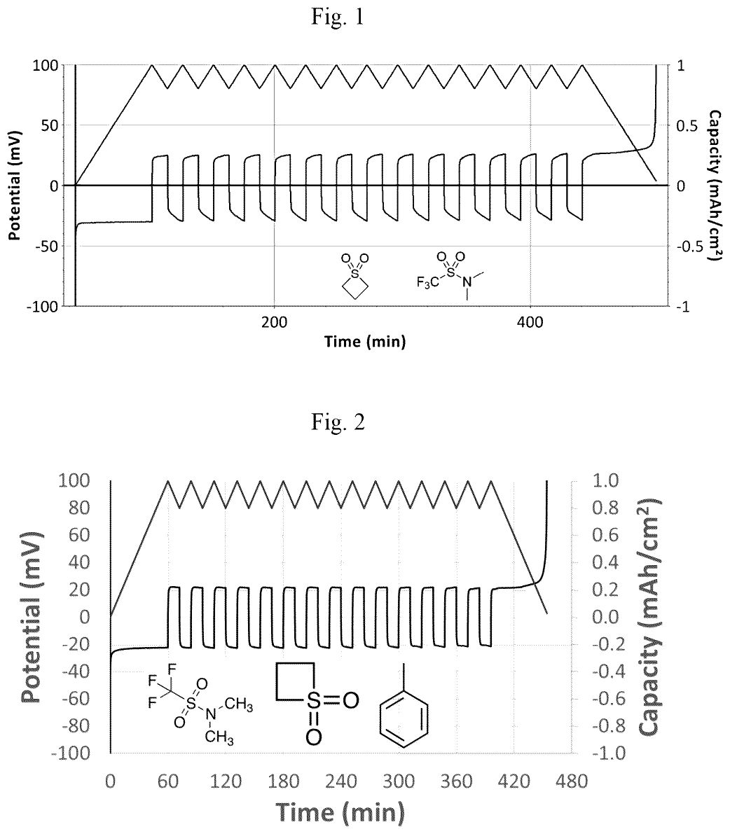

A mixture of 50:50 TT to sulfonamide with 2.5 mmol LiFSI achieved an average coulombic efficiency of 99% (Table 1, Electrolyte 1) (FIG. 1). Adding toluene equal to 5 wt. % (50 wt. % TT, 45 wt. % sulfonamide), the average CE increased to 99.2% (Table 1, Electrolyte 2). Increasing to 10 wt. % toluene (50% TT, 40% sulfonamide) improved the average CE further to ˜99.5% (Table 1, Electrolyte 3) (FIG. 2). The overpotential of lithium metal cycling with this electrolyte is very low at a total of ˜45 mV (combining plating and stripping potentials) at 1 mA cm-2.

The principle of adding a non-polar solvent to an electrolyte to improve performance can be applied to other metal anode systems based upon other alkali metals, alkaline earth metals, zinc or aluminum. For example, a magnesium electrolyte consisting of a [Mg2Cl3-6THF][HMDSAlCl3] (tetrahydrofuran—THF) (hexamethyl disilazane—HMDS) salt (0.25 M) in THE solvent achieved an average CE of 98.8% when stripped and plated at a rate of 1 mA cm-2 (Qc=1 mAh cm-2, QT=5 mAh cm-2) (FIG. 3). Adding 10 wt. % toluene (90% THF, 0.25 M [Mg2Cl3-6THF][HMDSAlCl3]) increased the average CE to 99.92% under the same testing conditions (FIG. 4).

Thus, in a first embodiment, a metal ion electrolyte composition is provided. The composition comprises: at least one electrolyte salt of a metal selected from the group consisting of an alkali metal, an alkaline earth metal, zinc, and aluminum; at least one solvent which solubilizes the at least one electrolyte salt; and up to 50 wt. % of at least one non-polar additive; wherein the at least one solvent which solubilizes the at least one electrolyte salt is selected from the group consisting of cyclic sulfones, cyclic sultones, cyclic ethers, partially fluorinated sulfonamides, fluorinated solvents, and glymes, the at least one nonpolar additive is selected from the group consisting of aromatic hydrocarbons, partially fluorinated aromatic hydrocarbons, fluorinated monoethers, fluorinated phosphate esters and fluorinated linear sulfones, and a coulombic efficiency of the electrolyte composition with respect to plating and stripping of the metal is at least 90%.

As described above, the initial work was directed to lithium metal anode systems and subsequently other metals as described herein investigated. The alkali metals include lithium, sodium, potassium, rubidium and cesium, preferably, lithium and sodium and most preferably lithium. The alkaline earth metals include magnesium and calcium, preferably, magnesium. Zinc and aluminum are also included.

Examples of cyclic sulfones and cyclic sultones are provided in U.S. application Ser. No. 17/586,302 and those examples are included herein by reference. Solvents which have been shown to contribute to enhanced CE include thietane-1,1-dioxide (TT), 1,3-propane sultone (PST) and sulfolane (SL).

Examples of cyclic ethers include tetrahydrofuran (THF) and 1,3-dioxolane (DOL) and examples of glyme solvents include monoglyme, diglyme, triglyme, and tetraglyme.

Examples of partially fluorinated sulfonamides are provided in U.S. application Ser. No. 17/586,302 and those examples are included herein by reference.

Examples of fluorinated solvents include 1-(2,6-dimethylphenyl)-2,2,2-trifluoroethanone (DMTFE), tris(2,2,2-trifluoroethyl)orthoformate (TFEO), bis(2,2,2-trifluoroethyl) ether (BTFE), 1,1,2,2-tetrafluoroethyl-2,2,3,3-tetrafluoropropylether (TTE), 4,4,6,6,7,7,9,9,10,10,12,12-Dodecafluoro-2,2,5,8,11,14-pentaoxapentadecane, 3,3,4,4,6,6,7,7,9,9,10,10-dodecafluoro-2,5,8,11-tetraoxadodecane, 2,2,3,3-tetrafluoro-1,4-dimethoxybutane, 1,2-difluorobenzene, α, α, α-trifluorotoluene, 3,5-bis(trifluoromethyl)benzene, tris 2,2,2-trifluoroethyl) phosphate, and 1,1′-sulfonlybis [2,2,2-trifluoroethane].

In selected preferred embodiments mixtures containing two or more of the listed solvents have been found to be effective to improve the CE of a metal electrolyte according to the present disclosure. Exemplary combinations include a cyclic sulfone and a partially fluorinated sulfonamide, and a cyclic sulfone and a fluorinated solvent. As described above, there is much latitude in formulating an electrolyte composition which contributes to high CE performance and solvent combinations of greatest utility may vary depending on the metal salt of the formulation, the concentration of the metal salt, and the non-polar additive employed among the variables to be considered.

Although specific formulation compositions are described herein, one of skill in the art will understand that within the metes and bounds of the present disclosure, combinations of solvent, metal salt and non-polar additives as described herein although not explicitly disclosed, are to be considered within the general disclosure.

As described above, lithium salt electrolytes were initially studied for the improvement of CE by addition of tertiary solvents as additives. The salts studied include lithium bis(trifluoromethane)sulfonimide (LiTFSI), lithium bis(fluorosulfonyl)imide (LiFSI), and lithium hexafluorophosphate (LiPF6); however; salts such as lithium bis(oxalato)borate (LiBOB), lithium difluoro(oxalato)borate (LiDFOB), lithium tetrafluoroborate (LiBF4), lithium difluorophosphate (LiPO2F2), lithium hexafluoroarsenate, lithium tetracyanoborate, lithium perchlorate, lithium tris((trifluoromethanesulfonyl)methanide, lithium tetrafluorooxalatophosphate. and lithium nitrate (LiNO3) are considered within the scope of this disclosure.

The concentration of the lithium salt is from 0.001 molal to 16 molal, preferably 0.01 molal to 10 molal and most preferably from 0.1 molal to 5.0 molal. Combinations of multiple lithium salts may lead to an effective increase in CE and combinations of from 2 to 5 electrolyte salts may be employed. For example, a combination of lithium bis(trifluoromethanesulfonyl)imide, lithium bis(fluorosulfonyl)imide, and lithium bis(oxalate)borate is one preferred combination. Other mixtures containing LiFSI with 1 to 4 of the salts listed above is considered as providing CE enhancement benefit in solvent systems as listed above including a tertiary solvent additive.

CE enhancing solvent systems employed in combination with the lithium salts include a combination of a cyclic sulfone, a cyclic sultone and a partially fluorinated sulfonamide. The cyclic sulfone may be one or more solvents selected from the group consisting of thietane-1,1-dioxide, and sulfolane and the cyclic sultone may be 1,3-propane sultone. The partially fluorinated sulfonamide may be one or more solvents selected from 1,1,1-trifluoro-N,N-dimethylmethanesulfonamide, N-butyl-1,1,1-trifluoro-N-methylmethanesulfonamide or a combination thereof.

The weight ratio of the solvent combinations including two solvents may vary from 1/99 to 99/1 as determined by the optimized CE value. When more than two solvents are employed the relative content of each solvent may vary within a full range of total content of solvent.

The content of the solvent components in total may range from 50 wt. % to 98 wt. %, preferably from 60 wt % to 95 wt. % and most preferably from 75 wt. % to 90 wt. % relative to the total weight of the electrolyte composition.

Combinations of these solvents may include thietane-1,1-dioxide and 1,1,1-trifluoro-N,N-dimethylmethanesulfonamide; thietane-1,1-dioxide, sulfolane, and 1,1,1-trifluoro-N,N-dimethylmethanesulfonamide; thietane-1,1-dioxide, 1,3-propane sultone and 1,1,1-trifluoro-N,N-dimethylmethanesulfonamide.

Thietane-1,1-dioxide has a high melting point, which provides safety benefits, such as a low volatility and a low flash point to the electrolyte composition.

Other CE enhancing combinations of solvents include the combination of a cyclic sulfone and one or more of fluorinated solvents including 1-(2,6-dimethylphenyl)-2,2,2-trifluoroethanone (DMTFE), tris(2,2,2-trifluoroethyl)orthoformate (TFEO), bis(2,2,2-trifluoroethyl) ether (BTFE), 1,1,2,2-tetrafluoroethyl-2,2,3,3-tetrafluoropropylether (TTE), 4,4,6,6,7,7,9,9,10,10,12,12-Dodecafluoro-2,2,5,8,11,14-pentaoxapentadecane, 3,3,4,4,6,6,7,7,9,9,10,10-dodecafluoro-2,5,8,11-tetraoxadodecane, 2,2,3,3-tetrafluoro-1,4-dimethoxybutane, 1,2-difluorobenzene, α,α,α-trifluorotoluene, 3,5-bis(trifluoromethyl)benzene, bis(2,2,2-trifluoroethyl) ether, tris(2,2,2-trifluoroethyl) phosphate, and 1,1′-sulfonlybis[2,2,2-trifluoroethane].

Combinations of a cyclic sulfone and from 2 to 8 fluorinated solvents as listed above may be employed.

Combinations of one or more fluorinated solvents with thietane-1,1-dioxide may provide an effective solvent system for the lithium salts listed above and when a tertiary solvent is added according to the present disclosure, high CE enhancement may be obtained.

The nonpolar additive employed as the tertiary solvent is selected from aromatic hydrocarbons, partially fluorinated aromatic hydrocarbons, fluorinated monoethers, fluorinated polyethers, fluorinated phosphate esters and fluorinated linear sulfones. Examples of aromatic hydrocarbons include but are not limited to toluene, xylenes, mesitylene and tetralin. Toluene as demonstrated in the examples above is an effective CE enhancing additive.

Partially fluorinated aromatic hydrocarbons include but are not limited to fluorobenzene, difluorobenzene, trifluoromethylbenzene and di-trifluoromethylbenzene.

Fluorinated monoethers include but are not limited to bis-(1,1,1-trifluoroethyl)ether, 1,1,2,2-tetrafluoro-3-(1,1,2,2-tetrafluoroethoxy)-propane (TFTFEP), methyl nanofluorobutyl ether (MFE), ethyl nanofluorobutyl ether (EFE), 2-trifluoromethyl-3-methoxyperfluoropentane (TMMP), and 2-(trifluoro-2-fluoro-3-difluoropropoxy)3-difluoro-4-fluoro-5-trifluoropentane (TPTP).

Examples of partly fluorinated polyethers are provided in the description of the Examples.

Fluorinated phosphate esters include but are not limited to trimethyl phosphate, bis(2,2,2-trifluoroethyl) methyl phosphate (BMP) and 2,2,2-trifluoroethyl) diethyl phosphate.

Fluorinated linear sulfones include but are not limited to trifluoromethyl ethyl sulfone (FMES), trifluoromethyl propyl sulfone (FMPS), and trifluoromethyl isopropyl sulfone (FMIS).

The content of the tertiary solvent is adjusted to optimize the CE based upon the solvent composition and the metal salt employed and may be from 0.15 wt. % to 25 wt. %, preferably 2.0 wt. % to 20.wt % and most preferably from 2.5 wt. % to 15 wt. % relative to the total weight of the electrolyte composition. In one embodiment the tertiary solvent is toluene, and the content of the toluene is from 0.15 wt. % to 25 wt. %, preferably 1.0 wt. % to 15 wt. % and most preferable 2.0 wt. % to 12 wt. %, relative to the total weight of the electrolyte composition. In other embodiments the tertiary solvent may be a combination of two or more the components listed above.

In preparing the electrolyte compositions, the solvent, metal salt and tertiary solvent are combined in an inert atmosphere which is essentially free of oxygen and moisture. The order of mixing is not limited; however, for ease of dissolution of the metal salt, it may be useful to mix the solvent and metal salt, dissolve the metal salt in the solvent and then add the tertiary solvent to the solution. In a case where the solvent is a solid at 25° C. such as for example, thietane-1,1-dioxide, the solvent may be melted prior to mixing with the metal salt or after the mixing is completed. The resulting non-aqueous electrolyte composition is a homogeneous solution.

Although the foregoing description is directed to lithium electrolytes, the same or similar composition may be employed to prepare nonaqueous compositions for use with sodium metal anodes and anodes containing alkali metals other than lithium and sodium.

These concepts may also be applied to obtain non-aqueous electrolyte compositions for alkaline earth metals, zinc, and aluminum.

An electrolyte composition containing [Mg2Cl3-6THF][HMDSAlCl3] is described above. Other magnesium salts, including magnesium monocarborane, magnesium aluminates, and magnesium borates are suitable in these electrolyte formulations. Salts such as Mg[TFSI]2, Mg(ClO4)2, Mg(BPh2Bu2), Mg(AlCl2BuEt)2, Mg(HMDS)2, Mg(BH4)2, MgB12H12, Mg (CB11H12) may also be employed.

Solvents which have been determined to be useful for alkaline earth electrolyte compositions include cyclic ethers, fluorinated solvents and glymes which have been previously described.

Solvent compositions containing multiple solvents and mixtures thereof may be employed to dissolve the metal salt and obtain the desired homogeneous solution. For example, combinations of two or more glymes may be employed or a combination of a cyclic ether and one or more glymes may be employed. Additionally, combinations of cyclic ethers and fluorinated solvents may be employed to obtain a high M solution of the alkaline earth metal salt, zinc salt or aluminum salt.

The weight ratio of the solvent combinations including two solvents may vary from 1/99 to 99/1 as determined by the optimized CE value. When more than two solvents are employed the relative content of each solvent may vary within a full range of total content of solvent.

The content of the solvent components in total may range from 50 wt. % to 98 wt. %, preferably from 60 wt % to 95 wt. % and most preferably from75 wt. % to 90 wt. % relative to the total weight of the electrolyte composition.

The content of the metal salt of the alkaline earth metal, zinc or aluminum may be from 0.01 M to 1.0 M, preferably from 0.05 M to 0.75 M and most preferably, from 0.1 M to 0.5 M.

The tertiary solvent additive includes the aromatic hydrocarbons, partially fluorinated aromatic hydrocarbons, fluorinated monoethers, fluorinated phosphate esters and fluorinated linear sulfones described above. One or more of these non-polar additives may be included.

The content of the tertiary solvent is adjusted to optimize the CE based upon the solvent composition and the metal salt employed and may be from 0.15 wt. % to 25 wt. %, preferably 2.0 wt. % to 20.wt % and most preferably from 2.5 wt. % to 15 wt. % relative to the total weight of the electrolyte composition. In one embodiment the tertiary solvent is toluene, and the content of the toluene is from 0.15 wt. % to 25 wt. %, preferably 1.0 wt. % to 15 wt. % and most preferable 2.0 wt. % to 12 wt. %, relative to the total weight of the electrolyte composition. In other embodiments the tertiary solvent may be a combination of two or more the components listed above.

### EXAMPLES

### Example 1

### Synthesis of a Magnesium Electrolyte Salt

To synthesize the [Mg2C13-6THF][HMDSAlCl3] salt the following procedure was followed. In an atmosphere from which oxygen and water vapors were rigorously excluded, such as in an argon-filled glovebox, anhydrous THF was cooled to 0° C. Anhydrous aluminum trichloride (AlCl3) was added to the THF. This reaction was allowed to slowly warm to room temperature once all the AlCl3 was added. A clear solution resulted, which could be further diluted with THF if desired.

In a separate vessel, anhydrous THF and hexamethyldisilazane (HMDS) were mixed. Freshly prepared ethyl magnesium chloride (EtMgCl) was added slowly to yield HMDSMgCl. The reaction was allowed to stir for at least 8 hours. Then, the previously prepared AlCl3/THF mixture was mixed with 3 equivalents of freshly prepared HMDSMgCl. This mixture was allowed to stir for at least 8 hours. Anhydrous hexanes were then added to the vessel containing HMDSMgCl, AlCl3, and THF to form a secondary layer. Crystals were formed by slow diffusion. The resulting crystals were separated, washed with hexane and dried under vacuum to furnish a white crystalline product.

### Example 2

### Preparation of a Magnesium Electrolyte Containing a Tertiary Solvent

The magnesium salt ([Mg2Cl3-6THF][HMDSAlCl3]) prepared in Example 1, anhydrous THF, and toluene were mixed together in an argon-filled glove box providing an atmosphere from which oxygen and water vapors were rigorously excluded. Stirring was continued until a homogeneous solution was obtained.

### Example 3

### Preparation of a Magnesium Electrolyte Containing Multiple Types of Glyme and a Tertiary Solvents

The magnesium salt ([Mg2Cl3-6THF][HMDSAlCl3]) prepared in Example 1, ethers, and toluene were mixed together in an argon-filled glove box providing an atmosphere from which oxygen and water vapors were rigorously excluded. Stirring was continued until a homogeneous solution was obtained.

### Example 4

### Preparation of a Magnesium Electrolyte Containing Fluorinated Solvents and a Tertiary Solvent

The magnesium salt ([Mg2Cl3-6THF][HMDSAlCl3]) prepared in Example 1, fluorinated solvents, and toluene were mixed together in an argon-filled glove box providing an atmosphere from which oxygen and water vapors were rigorously excluded. Stirring was continued until a homogeneous solution was obtained.

### Example 5

### Preparation of an Aluminum Electrolyte Containing a Tertiary Solvent

1-ethyl-3-methylimidazolium chloride (EMIm) that had been dried under heat and vacuum to remove water was mixed with anhydrous AlCl3 in an argon-filled glove box providing an atmosphere from which oxygen and water vapors were rigorously excluded. Toluene was then added to the mixture. The molar ratio of EMIm to AlCl3 can range from 1.0 M to 2.0 M. Stirring was continued until a homogeneous solution was obtained.

### Example 6

### Preparation of a Lithium Electrolyte Containing Lithium Hexafluorophosphate Dissolved in a Mixture of Sulfone and Fluorinated Sulfonamide

Anhydrous lithium hexafluorophosphate (0.1514 g, 1 mmol) was placed into a vial equipped with a magnet stirring bar in an argon-filled dry box with impurities content O2<0.1 ppm and H2O<0.1 ppm. To that vial, anhydrous 1,1,1-trifluoro-N,N-dimethylmethanesulfonamide (0.2 g) was added. After that, anhydrous thietane-1,1-dioxide (0.8 g) was added to the vial in portions, allowing each portion to dissolve before the addition of the next one. The vial was capped, and its content was stirred until a clear homogenous solution was obtained.

Other examples can include amounts of the reagents ranging in any measurable intervals. The fraction of the fluorinated sulfonamide may range from 1 wt % of the liquid phase to 99 wt % of the liquid phase, the fraction of thietane-1,1-dioxide may range from 1 wt % of the liquid phase to 99 wt % of the liquid phase, and the amounts of lithium hexafluorophosphate may be adjusted to produce a solution with concentration ranging from 0.001 molal to 7 molal.

### Example 7

### Preparation of a Lithium Electrolyte Containing Lithium Bis(Fluorosulfonyl)Imide Dissolved in a Mixture of Sultone and Fluorinated Sulfonamide

Anhydrous lithium bis(fluorosulfonyl)imide (0.93535 g, 5 mmol) was placed into a vial equipped with a magnet stirring bar in an argon-filled dry box with impurities content O2<0.1 ppm and H2O<0.1 ppm. To that vial, anhydrous 1,1,1-trifluoro-N,N-dimethylmethanesulfonamide (0.2 g) and 1,3-propane sultone (0.8 g) were added. The vial was capped, and its content was stirred until a clear homogenous solution was obtained.

Optionally, 1,3-propane sultone can be weighed as a solid before the addition to the vial. Optionally, 1,3-propane sultone can be melted and added to the vial as a liquid.

Other examples can include amounts of the reagents ranging in any measurable intervals. The fraction of the fluorinated sulfonamide may range from 1 wt % of the liquid phase to 99 wt % of the liquid phase, the fraction of 1,3-propane sultone may range from 1 wt % of the liquid phase to 99 wt % of the liquid phase, and the amounts of lithium bis(fluorosulfonyl)imide may be adjusted to produce a solution with concentration ranging from 0.001 molal to 16 molal.

### Example 8

### Preparation of a Lithium Electrolyte Containing Lithium Bis(Fluorosulfonyl)Imide Dissolved in a Mixture of a Room-Temperature-Solid Sulfone, Fluorinated Polyether, and Fluorinated Sulfonamide

Anhydrous lithium bis(fluorosulfonyl)imide (0.93535 g, 5 mmol) was placed into a vial equipped with a magnet stirring bar in an argon-filled dry box with impurities content O2<0.1 ppm and H2O<0.1 ppm. To that vial, anhydrous 1,1,1-trifluoro-N,N-dimethylmethanesulfonamide (0.2 g), thietane-1,1-dioxide (0.2 g), and partly fluorinated polyether CH3—O—CH2CF2—O—CF2CF2—O—CF2CH2—O—CH3 (0.6 g) were added. The vial was capped, and its content was stirred until a clear homogenous solution was obtained.

Optionally, thietane-1,1-dioxide can be added in parts and every next part can be added after liquification of the sufficient fraction of the previously added parts. Other examples can include other fluorinated ethers and polyethers. Other examples can include amounts of the reagents ranging in any measurable intervals. The fraction of each of the solvent component may range from 1 wt % of the liquid phase to 99 wt % of the liquid phase. The amounts of lithium bis(fluorosulfonyl)imide may be adjusted to produce a solution with concentration ranging from 0.001 molal to 16 molal.

### Example 9

### Preparation of a Lithium Electrolyte Containing Lithium Bis(Fluorosulfonyl)Imide Dissolved in a Mixture of a Sulfone Having a Melting Point Slightly Exceeding Room Temperature, Fluorinated Polyether, and Fluorinated Sulfonamide

Anhydrous lithium bis(fluorosulfonyl)imide (0.93535 g, 5 mmol) was placed into a vial equipped with a magnet stirring bar in an argon-filled dry box with impurities content O2<0.1 ppm and H2O<0.1 ppm. To that vial, anhydrous 1,1,1-trifluoro-N,N-dimethylmethanesulfonamide (0.2 g), pre-melted sulfolane (0.2 g), and partly fluorinated polyether CH3—O—CH2CF2—O—CF2CF2—O—CF2CH2—O—CH3 (0.6 g) were added. The vial was capped, and its content was stirred until a clear homogenous solution was obtained.

Optionally, sulfolane can be weighed and then added as a solid.

Other examples can include other fluorinated ethers and polyethers. Other examples can include amounts of the reagents ranging in any measurable intervals. The fraction of each of the solvent component may range from 1 wt % of the liquid phase to 99 wt % of the liquid phase. The amounts of lithium bis(fluorosulfonyl)imide may be adjusted to produce a solution with concentration ranging from 0.001 molal to 16 molal.

### Example 10

### Preparation of a Lithium Electrolyte Containing Lithium Bis(Fluorosulfonyl)Imide Dissolved in a Mixture of a Fluorinated Polyether and Two Sulfones

Anhydrous lithium bis(fluorosulfonyl)imide (0.93535 g, 5 mmol) was placed into a vial equipped with a magnet stirring bar in an argon-filled dry box with impurities content O2<0.1 ppm and H2O<0.1 ppm. To that vial, pre-melted sulfolane (0.2 g), thietane-1,1-dioxide (0.2 g), and partly fluorinated polyether CH3—O—CH2CF2—O—CF2CF2—O—CF2CH2—O—CH3 (0.6 g) were added. The vial was capped, and its content was stirred until a clear homogenous solution was obtained.

Optionally, sulfolane can be weighed and then added as a solid. Optionally, thietane-1,1-dioxide can be added in parts and every next part can be added after liquification of the sufficient fraction of the previously added parts. Other examples can include other fluorinated ethers and polyethers. Other examples can include amounts of the reagents ranging in any measurable intervals. The fraction of each of the solvent component may range from 1 wt % of the liquid phase to 99 wt % of the liquid phase. The amounts of lithium bis(fluorosulfonyl)imide may be adjusted to produce a solution with concentration ranging from 0.001 molal to 16 molal.

### Example 11

### Preparation of a Lithium Electrolyte Containing Lithium Bis(Fluorosulfonyl)Imide Dissolved in a Mixture of a Glyme, Fluorinated Polyether and Two Sulfones

Anhydrous lithium bis(fluorosulfonyl)imide (0.93535 g, 5 mmol) was placed into a vial equipped with a magnet stirring bar in an argon-filled dry box with impurities content O2<0.1 ppm and H2O<0.1 ppm. To that vial, pre-melted sulfolane (0.2 g), thietane-1,1-dioxide (0.2 g), glyme (0.3 g), and partly fluorinated polyether CH3—O—CH2CF2—O—CF2CF2—O—CF2CH2—O—CH3 (0.3 g) were added. The vial was capped, and its content was stirred until a clear homogenous solution was obtained.

Optionally, sulfolane can be weighed and then added as a solid. Optionally, thietane-1,1-dioxide can be added in parts and every next part can be added after liquification of the sufficient fraction of the previously added parts. Optionally, other glymes such as diglyme, triglyme, tetraglyme, and their higher homologs, could be used instead of glyme. Other examples can include other fluorinated ethers and polyethers. Other examples can include amounts of the reagents ranging in any measurable intervals. The fraction of each of the solvent component may range from 1 wt % of the liquid phase to 99 wt % of the liquid phase. The amounts of lithium bis(fluorosulfonyl)imide may be adjusted to produce a solution with concentration ranging from 0.001 molal to 16 molal.

### Example 12

### Preparation of a Lithium Electrolyte Containing Lithium Bis(Fluorosulfonyl)Imide Dissolved in a Mixture of a Glyme, Fluorinated Polyether, a Sulfone, and a Fluorinated Sulfonamide

Anhydrous lithium bis(fluorosulfonyl)imide (0.93535 g, 5 mmol) was placed into a vial equipped with a magnet stirring bar in an argon-filled dry box with impurities content O2<0.1 ppm and H2O<0.1 ppm. To that vial, pre-melted sulfolane (0.2 g), anhydrous 1,1,1-trifluoro-N,N-dimethylmethanesulfonamide (0.2 g), glyme (0.3 g), and partly fluorinated polyether CH3—O—CH2CF2—O—CF2CF2—O—CF2CH2—O—CH3 (0.3 g) were added. The vial was capped, and its content was stirred until a clear homogenous solution was obtained.

Optionally, sulfolane can be weighed and then added as a solid. Optionally, other glymes such as diglyme, triglyme, tetraglyme, and their higher homologs, could be used instead of glyme. Other examples can include other fluorinated ethers and polyethers. Other examples can include amounts of the reagents ranging in any measurable intervals. The fraction of each of the solvent component may range from 1 wt % of the liquid phase to 99 wt % of the liquid phase. The amounts of lithium bis(fluorosulfonyl)imide may be adjusted to produce a solution with concentration ranging from 0.001 molal to 16 molal.

### Example 13

### Preparation of a Lithium Electrolyte Containing Lithium Bis(Fluorosulfonyl)Imide Dissolved in a Mixture of a Sulfone and a Fluorinated Sulfonamide

Anhydrous lithium bis(fluorosulfonyl)imide (0.93535 g, 5 mmol) was placed into a vial equipped with a magnet stirring bar in an argon-filled dry box with impurities content O2<0.1 ppm and H2O<0.1 ppm. To that vial, anhydrous 1,1,1-trifluoro-N,N-dimethylmethanesulfonamide (0.2 g) was added. Then, thietane-1,1-dioxide (0.8 g) was added in parts so that every part was added after liquification of the sufficient fraction of the previously added parts. The vial was capped, and its content was stirred until a clear homogenous solution was obtained.

Other examples can include other lithium salts, sulfones and fluorinated sulfonamides. Other examples can include amounts of the reagents ranging in any measurable intervals. The fraction of each of the solvent component may range from 1 wt % of the liquid phase to 99 wt % of the liquid phase. The amounts of lithium bis(fluorosulfonyl)imide, or another lithium salt, may be adjusted to produce a solution with concentration ranging from 0.001 molal to 16 molal.

### Example 14

### Preparation of a Lithium Electrolyte Containing Lithium Bis(Fluorosulfonyl)Imide Dissolved in a Mixture of a Sulfone and a Fluorinated Sulfonamide

Anhydrous lithium bis(fluorosulfonyl)imide (0.46768 g, 2.5 mmol) was placed into a vial equipped with a magnet stirring bar in an argon-filled dry box with impurities content O2<0.1 ppm and H2O<0.1 ppm. To that vial, anhydrous 1,1,1-trifluoro-N,N-dimethylmethanesulfonamide (0.1 g) was added. Then, thietane-1,1-dioxide (0.4 g) was added in parts so that every part was added after liquification of the sufficient fraction of the previously added parts. The vial was capped, and its content was stirred until a clear homogenous solution was obtained.

Other examples can include other lithium salts, sulfones and fluorinated sulfonamides. Other examples can include amounts of the reagents ranging in any measurable intervals. The fraction of each of the solvent component may range from 1 wt % of the liquid phase to 99 wt % of the liquid phase. The amounts of lithium bis(fluorosulfonyl)imide, or another lithium salt, may be adjusted to produce a solution with concentration ranging from 0.001 molal to 16 molal.

### Example 15

### Preparation of a Lithium Electrolyte Containing Lithium Bis(Fluorosulfonyl)Imide Dissolved in a Mixture of Two Sulfones

Anhydrous lithium bis(fluorosulfonyl)imide (0.18707 g, 1 mmol) was placed into a vial equipped with a magnet stirring bar in an argon-filled dry box with impurities content O2<0.1 ppm and H2O<0.1 ppm. To that vial, pre-melted sulfolane (0.1 g) was added. After that, thietane-1,1-dioxide (0.4 g) was added. The vial was capped, and its content was stirred until a clear homogenous solution was obtained.

Optionally, sulfolane can be weighed and then added as a solid. Optionally, thietane-1,1-dioxide can be added in parts and every next part can be added after liquification of the sufficient fraction of the previously added parts. Other examples can include amounts of the reagents ranging in any measurable intervals. The fraction of each of the solvent component may range from 1 wt % of the liquid phase to 99 wt % of the liquid phase. The amounts of lithium bis(fluorosulfonyl)imide may be adjusted to produce a solution with concentration ranging from 0.001 molal to 16 molal.

### Example 16

### Preparation of a Lithium Electrolyte Containing Lithium Bis(Fluorosulfonyl)Imide Dissolved in a Mixture of a Sulfone and a Sultone

Anhydrous lithium bis(fluorosulfonyl)imide (0.18707 g, 1 mmol) was placed into a vial equipped with a magnet stirring bar in an argon-filled dry box with impurities content O2<0.1 ppm and H2O<0.1 ppm. To that vial, pre-melted 1,3-propane sultone (0.1 g) was added. After that, thietane-1,1-dioxide (0.4 g) was added. The vial was capped, and its content was stirred until a clear homogenous solution was obtained.

Optionally, 1,3-propane sultone can be weighed and then added as a solid. Optionally, thietane-1,1-dioxide can be added in parts and every next part can be added after liquification of the sufficient fraction of the previously added parts. Other examples can include amounts of the reagents ranging in any measurable intervals. The fraction of each of the solvent component may range from 1 wt % of the liquid phase to 99 wt % of the liquid phase. The amounts of lithium bis(fluorosulfonyl)imide may be adjusted to produce a solution with concentration ranging from 0.001 molal to 16 molal.

### Example 17

### Preparation of a Lithium Electrolyte Containing Lithium Bis(Fluorosulfonyl)Imide Dissolved in a Mixture of Two Sulfones and Fluorinated Sulfonamide

Anhydrous lithium bis(fluorosulfonyl)imide (0.18707 g, 1 mmol) was placed into a vial equipped with a magnet stirring bar in an argon-filled dry box with impurities content O2<0.1 ppm and H2O<0.1 ppm. To that vial, anhydrous 1,1,1-trifluoro-N,N-dimethylmethanesulfonamide (0.025 g) and pre-melted sulfolane (0.075 g) were added. After that, thietane-1,1-dioxide (0.4 g) was added. The vial was capped, and its content was stirred until a clear homogenous solution was obtained.

Optionally, sulfolane can be weighed as a solid before the addition to the vial. Optionally, thietane-1,1-dioxide can be added in parts and every next part can be added after liquification of the sufficient fraction of the previously added parts. Other examples can include amounts of the reagents ranging in any measurable intervals. The fraction of each of the solvent component may range from 1 wt % of the liquid phase to 99 wt % of the liquid phase. The amounts of lithium bis(fluorosulfonyl)imide may be adjusted to produce a solution with concentration ranging from 0.001 molal to 16 molal.

### Example 18

### Preparation of a Lithium Electrolyte Containing Lithium Bis(Fluorosulfonyl)Imide Dissolved in a Mixture of Sulfone, Sultone, and Fluorinated Sulfonamide

Anhydrous lithium bis(fluorosulfonyl)imide (0.18707 g, 1 mmol) was placed into a vial equipped with a magnet stirring bar in an argon-filled dry box with impurities content O2<0.1 ppm and H2O<0.1 ppm. To that vial, anhydrous 1,1,1-trifluoro-N,N-dimethylmethanesulfonamide (0.025 g) and pre-melted 1,3-propane sultone (0.075 g) were added. After that, thietane-1,1-dioxide (0.4 g) was added. The vial was capped, and its content was stirred until a clear homogenous solution was obtained.

Optionally, 1,3-propane sultone can be weighed as a solid before the addition to the vial. Optionally, thietane-1,1-dioxide can be added in parts and every next part can be added after liquification of the sufficient fraction of the previously added parts. Other examples can include amounts of the reagents ranging in any measurable intervals. The fraction of each of the solvent component may range from 1 wt % of the liquid phase to 99 wt % of the liquid phase. The amounts of lithium bis(fluorosulfonyl)imide may be adjusted to produce a solution with concentration ranging from 0.001 molal to 16 molal.

### Example 19

### Preparation of a Lithium Electrolyte Containing Lithium Bis(Fluorosulfonyl)Imide Dissolved in a Mixture of Sulfone, Fluorinated Polyether, and Fluorinated Sulfonamide

Anhydrous lithium bis(fluorosulfonyl)imide (0.18707 g, 1 mmol) was placed into a vial equipped with a magnet stirring bar in an argon-filled dry box with impurities content O2<0.1 ppm and H2O<0.1 ppm. To that vial, anhydrous 1,1,1-trifluoro-N,N-dimethylmethanesulfonamide (0.025 g) and partly fluorinated polyether CH3—O—CH2CF2—O—CF2CF2—O—CF2CH2—O—CH3 (0.075 g) were added. After that, thietane-1,1-dioxide (0.4 g) was added. The vial was capped, and its content was stirred until a clear homogenous solution was obtained.

Optionally, thietane-1,1-dioxide can be added in parts and every next part can be added after liquification of the sufficient fraction of the previously added parts. Other examples can include amounts of the reagents ranging in any measurable intervals. The fraction of each of the solvent component may range from 1 wt % of the liquid phase to 99 wt % of the liquid phase. The amounts of lithium bis(fluorosulfonyl)imide may be adjusted to produce a solution with a concentration ranging from 0.001 molal to 16 molal.

### Example 20

### Preparation of a Lithium Electrolyte Containing Lithium Bis(Fluorosulfonyl)Imide Dissolved in a Mixture of Sulfone, Fluorinated Polyether, and Fluorinated Sulfonamide

Anhydrous lithium bis(fluorosulfonyl)imide (0.18707 g, 1 mmol) was placed into a vial equipped with a magnet stirring bar in an argon-filled dry box with impurities content O2<0.1 ppm and H2O<0.1 ppm. To that vial, anhydrous 1,1,1-trifluoro-N,N-dimethylmethanesulfonamide (0.025 g) and partly fluorinated polyether CH3—O—CH2CF2—O—CF2CF2—O—CF2CF2—O—CF2CH2—O—CH3 (0.15 g) were added. After that, thietane-1,1-dioxide (0.325 g) was added. The vial was capped, and its content was stirred until a clear homogenous solution was obtained.

Optionally, thietane-1,1-dioxide can be added in parts and every next part can be added after liquification of the sufficient fraction of the previously added parts. Other examples can include amounts of the reagents ranging in any measurable intervals. The fraction of each of the solvent component may range from 1 wt % of the liquid phase to 99 wt % of the liquid phase. The amounts of lithium bis(fluorosulfonyl)imide may be adjusted to produce a solution with a concentration ranging from 0.001 molal to 16 molal.

### Example 21

### Preparation of a Lithium Electrolyte Containing Lithium Bis(Fluorosulfonyl)Imide Dissolved in a Mixture of Sulfone, Fluorinated Sulfonamide, and Toluene

Anhydrous lithium bis(fluorosulfonyl)imide (0.18707 g, 1 mmol) was placed into a vial equipped with a magnet stirring bar in an argon-filled dry box with impurities content O2<0.1 ppm and H2O<0.1 ppm. To that vial, anhydrous 1,1,1-trifluoro-N,N-dimethylmethanesulfonamide (0.050 g) and hexane (0.050 g) were added. After that, thietane-1,1-dioxide (0.4 g) was added. The vial was capped, and its content was stirred until a clear homogenous solution was obtained.

Optionally, thietane-1,1-dioxide can be added in parts and every next part can be added after liquification of the sufficient fraction of the previously added parts. Other examples can include amounts of the reagents ranging in any measurable intervals. The fraction of each of the solvent component may range from 1 wt % of the liquid phase to 99 wt % of the liquid phase. The amounts of lithium bis(fluorosulfonyl)imide may be adjusted to produce a solution with a concentration ranging from 0.001 molal to 16 molal.

### Example 22

### Preparation of a Lithium Electrolyte Containing Lithium Bis(Fluorosulfonyl)Imide Dissolved in a Mixture of Sulfone, Fluorinated Sulfonamide, and Hexane

Anhydrous lithium bis(fluorosulfonyl)imide (0.18707 g, 1 mmol) was placed into a vial equipped with a magnet stirring bar in an argon-filled dry box with impurities content O2<0.1 ppm and H2O<0.1 ppm. To that vial, anhydrous 1,1,1-trifluoro-N,N-dimethylmethanesulfonamide (0.075 g) and hexane (0.025 g) were added. After that, thietane-1,1-dioxide (0.4 g) was added. The vial was capped, and its content was stirred until a clear homogenous solution was obtained.

Optionally, thietane-1,1-dioxide can be added in parts and every next part can be added after liquification of the sufficient fraction of the previously added parts. Other examples can include amounts of the reagents ranging in any measurable intervals. The fraction of each of the solvent component may range from 1 wt % of the liquid phase to 99wt % of the liquid phase. The amounts of lithium bis(fluorosulfonyl)imide may be adjusted to produce a solution with a concentration ranging from 0.001 molal to 16 molal.

### Example 23

### Preparation of a Lithium Electrolyte Containing Lithium Bis(Fluorosulfonyl)Imide Dissolved in a Mixture of Sulfone, Fluorinated Sulfonamide, and Fluorobenzene

Anhydrous lithium bis(fluorosulfonyl)imide (0.18707 g, 1 mmol) was placed into a vial equipped with a magnet stirring bar in an argon-filled dry box with impurities content O2<0.1 ppm and H2O<0.1 ppm. To that vial, anhydrous 1,1,1-trifluoro-N,N-dimethylmethanesulfonamide (0.075 g) and fluorobenzene (0.025 g) were added. After that, thietane-1,1-dioxide (0.4 g) was added. The vial was capped, and its content was stirred until a clear homogenous solution was obtained.

Optionally, thietane-1,1-dioxide can be added in parts and every next part can be added after liquification of the sufficient fraction of the previously added parts. Other examples can include amounts of the reagents ranging in any measurable intervals. The fraction of each of the solvent component may range from 1 wt % of the liquid phase to 99wt % of the liquid phase. The amounts of lithium bis(fluorosulfonyl)imide may be adjusted to produce a solution with a concentration ranging from 0.001 molal to 16 molal.

### Example 24

Preparation of a Lithium Electrolyte Containing Lithium Bis(Fluorosulfonyl)Imide Dissolved in a Mixture of Sulfone, Fluorinated Sulfonamide, and o-Difluorobenzene

Anhydrous lithium bis(fluorosulfonyl)imide (0.18707 g, 1 mmol) was placed into a vial equipped with a magnet stirring bar in an argon-filled dry box with impurities content O2<0.1 ppm and H2O<0.1 ppm. To that vial, anhydrous 1,1,1-trifluoro-N,N-dimethylmethanesulfonamide (0.075 g) and o-difluorobenzene (0.025 g) were added. After that, thietane-1,1-dioxide (0.4 g) was added. The vial was capped, and its content was stirred until a clear homogenous solution was obtained.

Optionally, thietane-1,1-dioxide can be added in parts and every next part can be added after liquification of the sufficient fraction of the previously added parts. Other examples can include amounts of the reagents ranging in any measurable intervals. The fraction of each of the solvent component may range from 1 wt % of the liquid phase to 99 wt % of the liquid phase. The amounts of lithium bis(fluorosulfonyl)imide may be adjusted to produce a solution with a concentration ranging from 0.001 molal to 16 molal.

### Example 25

Preparation of a Lithium Electrolyte Containing Lithium Bis(Fluorosulfonyl)Imide Dissolved in a Mixture of Sulfone, Fluorinated Sulfonamide, and m-Difluorobenzene

Anhydrous lithium bis(fluorosulfonyl)imide (0.18707 g, 1 mmol) was placed into a vial equipped with a magnet stirring bar in an argon-filled dry box with impurities content O2<0.1 ppm and H2O<0.1 ppm. To that vial, anhydrous 1,1,1-trifluoro-N,N-dimethylmethanesulfonamide (0.075 g) and m-difluorobenzene (0.025 g) were added. After that, thietane-1,1-dioxide (0.4 g) was added. The vial was capped, and its content was stirred until a clear homogenous solution was obtained.

Optionally, thietane-1,1-dioxide can be added in parts and every next part can be added after liquification of the sufficient fraction of the previously added parts. Other examples can include amounts of the reagents ranging in any measurable intervals. The fraction of each of the solvent component may range from 1 wt % of the liquid phase to 99 wt % of the liquid phase. The amounts of lithium bis(fluorosulfonyl)imide may be adjusted to produce a solution with a concentration ranging from 0.001 molal to 16 molal.

### Example 26

Preparation of a Lithium Electrolyte Containing Lithium Bis(Fluorosulfonyl)Imide Dissolved in a Mixture of Sulfone, Fluorinated Sulfonamide, and a,a,a-Trifluorotoluene

Anhydrous lithium bis(fluorosulfonyl)imide (0.18707 g, 1 mmol) was placed into a vial equipped with a magnet stirring bar in an argon-filled dry box with impurities content O2<0.1 ppm and H2O<0.1 ppm. To that vial, anhydrous 1,1,1-trifluoro-N,N-dimethylmethanesulfonamide (0.075 g) and a,a,a-trifluorotoluene (0.025 g) were added. After that, thietane-1,1-dioxide (0.4 g) was added. The vial was capped, and its content was stirred until a clear homogenous solution was obtained.

Optionally, thietane-1,1-dioxide can be added in parts and every next part can be added after liquification of the sufficient fraction of the previously added parts. Other examples can include amounts of the reagents ranging in any measurable intervals. The fraction of each of the solvent component may range from 1 wt % of the liquid phase to 99 wt % of the liquid phase. The amounts of lithium bis(fluorosulfonyl)imide may be adjusted to produce a solution with a concentration ranging from 0.001 molal to 16 molal.

### Example 27

### Preparation of a Lithium Electrolyte Containing Lithium Bis(Fluorosulfonyl)Imide Dissolved in a Mixture of Sulfone, Fluorinated Sulfonamide, and 3,5-Bis(Trifluoromethyl)Benzene

Anhydrous lithium bis(fluorosulfonyl)imide (0.18707 g, 1 mmol) was placed into a vial equipped with a magnet stirring bar in an argon-filled dry box with impurities content O2<0.1 ppm and H2O<0.1 ppm. To that vial, anhydrous 1,1,1-trifluoro-N,N-dimethylmethanesulfonamide (0.075 g) and 3,5-bis(trifluoromethyl)benzene (0.025 g) were added. After that, thietane-1,1-dioxide (0.4 g) was added. The vial was capped, and its content was stirred until a clear homogenous solution was obtained.

Optionally, thietane-1,1-dioxide can be added in parts and every next part can be added after liquification of the sufficient fraction of the previously added parts. Other examples can include amounts of the reagents ranging in any measurable intervals. The fraction of each of the solvent component may range from 1 wt % of the liquid phase to 99 wt % of the liquid phase. The amounts of lithium bis(fluorosulfonyl)imide may be adjusted to produce a solution with a concentration ranging from 0.001 molal to 16 molal.

### Example 28

### Preparation of a Lithium Electrolyte Containing Lithium Bis(Fluorosulfonyl)Imide Dissolved in a Mixture of Sulfone, Fluorinated Sulfonamide, and a Fluorinated Polyether

Anhydrous lithium bis(fluorosulfonyl)imide (0.18707 g, 1 mmol) was placed into a vial equipped with a magnet stirring bar in an argon-filled dry box with impurities content O2<0.1 ppm and H2O<0.1 ppm. To that vial, anhydrous 1,1,1-trifluoro-N,N-dimethylmethanesulfonamide (0.075 g) and a fluorinated polyether CH3—O—CH2CF2CF2CH2—O—CH3 (0.025 g) were added. After that, thietane-1,1-dioxide (0.4 g) was added. The vial was capped, and its content was stirred until a clear homogenous solution was obtained.

Optionally, thietane-1,1-dioxide can be added in parts and every next part can be added after liquification of the sufficient fraction of the previously added parts. Other examples can include amounts of the reagents ranging in any measurable intervals. The fraction of each of the solvent component may range from 1 wt % of the liquid phase to 99 wt % of the liquid phase. The amounts of lithium bis(fluorosulfonyl)imide may be adjusted to produce a solution with a concentration ranging from 0.001 molal to 16 molal.

### Example 29

### Preparation of a Lithium Electrolyte Containing Lithium Bis(Trifluoromethylsulfonyl)Imide Dissolved in a Mixture of Two Sulfones and Fluorinated Sulfonamide

Anhydrous lithium bis(trifluoromethylsulfonyl) mide (0.28708 g, 1 mmol) was placed into a vial equipped with a magnet stirring bar in an argon-filled dry box with impurities content O2<0.1 ppm and H2O<0.1 ppm. To that vial, anhydrous N-butyl-1,1,1-trifluoro-N-methylmethanesulfonamide (0.025 g) and pre-melted sulfolane (0.075 g) were added. After that, thietane-1,1-dioxide (0.4 g) was added. The vial was capped, and its content was stirred until a clear homogenous solution was obtained.

Optionally, sulfolane can be weighed as a solid before the addition to the vial. Optionally, thietane-1,1-dioxide can be added in parts and every next part can be added after liquification of the sufficient fraction of the previously added parts. Other examples can include amounts of the reagents ranging in any measurable intervals. The fraction of each of the solvent component may range from 1 wt % of the liquid phase to 99 wt % of the liquid phase. The amounts of lithium bis(fluorosulfonyl)imide may be adjusted to produce a solution with concentration ranging from 0.001 molal to 16 molal.

### Example 30

An Electrolyte Formulated from a Sulfone, Sulfonamide, and Toluene

Anhydrous thietane-1,1-dioxide, 1,1,1-trifluoro-N,N-dimethylmethanesulfonamide, toluene, and lithium bis(fluorosulfonyl)imide are mixed together in an atmosphere from which oxygen and water vapors were rigorously excluded. For example, that mixing could be performed in an argon-filled glove box. The weight fraction of thietane-1,1-dioxide in the solvent mixture (not including mass of salt) can range from 35% to 65%, the weight fraction of 1,1,1-trifluoro-N,N-dimethylmethanesulfonamide can range from 35% to 60% in the solvent mixture (not including mass of salt), and the weight fraction of toluene in the solvent mixture (not including mass of salt) can range from 5% to 20%. The weight fraction of salt (such as lithium bis(fluorosulfonyl)imide) in the total mixture can range from 15% to 60% but is most commonly 30-50%. Thietane-1,1-dioxide can be added as a solid. Optionally, thietane-1,1-dioxide can be melted before the addition and added in a liquid form.

Examples of other sulfones and sultones used in these formulations include, but are not limited to sulfolane, 1,3-propane sultone (PS), 1,3-oxathiolane-3,3-dioxide, and 1,3,2-dioxathiolane 2,2-dioxide.

### Example 31

### An Electrolyte Formulated From a Sulfone and Fluorinated Ether

Anhydrous thietane-1,1-dioxide or other sulfones and sultones, bis(2,2,2-trifluoroethyl) ether or other fluorinated solvents, and lithium bis(fluorosulfonyl)imide or another lithium salt are mixed together in an atmosphere from which oxygen and water vapors were rigorously excluded. For example, that mixing could be performed in an argon-filled glove box. The weight fraction of thietane-1,1-dioxide in the solvent mixture (not including mass of salt) can range from 35% to 65%, while that of fluorinated solvents can range from 35% to 65% in the solvent mixture (not including mass of salt). The weight ratio of salt (such as lithium bis(fluorosulfonyl)imide) to solvent can range from 15% to 60% but is most commonly 30-50%.

Examples of other sulfones and sultones used in these formulations include, but are not limited to sulfolane, 1,3-propane sultone (PS), 1,3-oxathiolane-3,3-dioxide, and 1,3,2-dioxathiolane 2,2-dioxide. Examples of other fluorinated solvents used in these formulations include, but are not limited to 1-(2,6-dimethylphenyl)-2,2,2-trifluoroethanone (DMTFE), tris(2,2,2-trifluoroethyl)orthoformate (TFEO), bis(2,2,2-trifluoroethyl) ether (BTFE), 1,1,2, 2-tetrafluoroethyl-2,2,3,3-tetrafluoropropylether (TTE), 4,4,6,6,7,7,9,9,10,10,12, 12-Dodecafluoro-2,2,5,8,11,14-pentaoxapentadecane, 3,3,4,4,6,6,7,7,9,9,10,10-dodecafluoro-2, 5,8,11-tetraoxadodecane, 2,2,3,3-tetrafluoro-1,4-dimethoxybutane, 1,2-difluorobenzene, a,a,a-trifluorotoluene, 3,5-bis(trifluoromethyl) benzene, bis(2,2,2-trifluoroethyl) ether, tris(2,2,2-trifluoroethyl) phosphase, and 1,1′-sulfonlybis [2,2,2-trifluoroethane]. Thietane-1,1-dioxide can be added as a solid. Optionally, thietane-1,1-dioxide can be melted before the addition and added in a liquid form.

### Example 32

An Electrolyte Formulated from a Sulfone, Fluorinated Ether, and Toluene

Anhydrous thietane-1,1-dioxide or other sulfones and sultones, bis(2,2,2-trifluoroethyl) ether and/or other fluorinated solvents, toluene, and lithium bis(fluorosulfonyl)imide or another lithium salt are mixed together in an atmosphere from which oxygen and water vapors were rigorously excluded. For example, that mixing could be performed in an argon-filled glove box. The weight fraction of thietane-1,1-dioxide in the solvent mixture can range from 35% to 65% (not including mass of salt), the weight fraction of fluorinated solvents in the solvent mixture (not including mass of salt) can range from 35% to 65%, and the weight fraction of toluene in the solvent mixture (not including mass of salt) can range from 5% to 20%. The weight fraction of fluorinated ether can be made up of a singular fluorinated ether or a combination of up to 6 fluorinated ethers. The weight ratio of salt (such as lithium bis(fluorosulfonyl)imide) to solvent can range from 15% to 60% but is most commonly 30-50%.

Examples of other sulfones and sultones used in these formulations include, but are not limited to sulfolane, 1,3-propane sultone (PS), 1,3-oxathiolane-3,3-dioxide, and 1,3,2-dioxathiolane 2,2-dioxide. Examples of other fluorinated solvents used in these formulations include, but are not limited to 1-(2,6-dimethylphenyl)-2,2,2-trifluoroethanone (DMTFE), tris(2,2,2-trifluoroethyl) orthoformate (TFEO), bis(2,2,2-trifluoroethyl) ether (BTFE), 1,1,2, 2-tetrafluoroethyl-2,2,3,3-tetrafluoropropylether (TTE), 4,4,6,6,7,7,9,9,10,10,12, 12-Dodecafluoro-2,2,5,8,11,14-pentaoxapentadecane, 3,3,4,4,6,6,7,7,9,9,10,10-dodecafluoro-2, 5,8,11-tetraoxadodecane, 2,2,3,3-tetrafluoro-1,4-dimethoxybutane, 1,2-difluorobenzene, a,a,a-trifluorotoluene, 3,5-bis(trifluoromethyl)benzene, bis(2,2,2-trifluoroethyl) ether, tris(2,2,2-trifluoroethyl) phosphase, and 1,1′-sulfonlybis[2,2,2-trifluoroethane]. Thietane-1,1-dioxide can be added as a solid. Optionally, thietane-1,1-dioxide can be melted before the addition and added in a liquid form.

### Example 33

### An Electrolyte Formulated From a Fluorinated Ether and Toluene

1,1,2,2-tetrafluoroethyl-2,2,3,3-tetrafluoropropylether (TTE) and/or other fluorinated solvents, toluene, and lithium bis(fluorosulfonyl)imide or another lithium salt are mixed together in an atmosphere from which oxygen and water vapors were rigorously excluded. For example, that mixing could be performed in an argon-filled glove box. The weight fraction of TTE in the solvent mixture (not including mass of salt) can range from 80% to 95%, and the weight fraction of toluene in the solvent mixture (not including mass of salt) can range from 5% to 20%. The weight fraction of fluorinated ether can be made up of a singular fluorinated ether or a combination of up to 6 fluorinated ethers. The weight ratio of salt (such as lithium bis(fluorosulfonyl)imide) to solvent can range from 15% to 60% but is most commonly 30-50%.

Fluorinated solvents used in these formulations include, but are not limited to 1-(2,6-dimethylphenyl)-2,2,2-trifluoroethanone (DMTFE), tris(2,2,2-trifluoroethyl) orthoformate (TFEO), bis(2,2,2-trifluoroethyl) ether (BTFE), 1,1,2, 2-tetrafluoroethyl-2,2,3,3-tetrafluoropropylether (TTE), 4,4,6,6,7,7,9,9,10,10,12, 12-Dodecafluoro-2,2,5,8,11,14-pentaoxapentadecane, 3,3,4,4,6,6,7,7,9,9,10,10-dodecafluoro-2, 5,8,11-tetraoxadodecane, 2,2,3,3-tetrafluoro-1,4-dimethoxybutane, 1,2-difluorobenzene, a,a,a-trifluorotoluene, 3,5-bis(trifluoromethyl)benzene, bis(2,2,2-trifluoroethyl) ether, tris(2,2,2-trifluoroethyl) phosphase, and 1,1′-sulfonlybis[2,2,2-trifluoroethane].

The above description is presented to enable a person skilled in the art to make and use the embodiments and aspects of the disclosure and is provided in the context of a particular application and its requirements. Various modifications to the preferred embodiments will be readily apparent to those skilled in the art, and the generic principles defined herein may be applied to other embodiments and applications without departing from the spirit and scope of the disclosure. Thus, this disclosure is not intended to be limited to the embodiments shown but is to be accorded the widest scope consistent with the principles and features disclosed herein. In this regard, certain embodiments within the disclosure may not show every benefit of the disclosure, considered broadly.

Obviously, numerous modifications and variations of the present invention are possible in light of the above teachings. It is therefore to be understood that within the scope of the appended claims, the invention may be practiced otherwise than as specifically described herein.

Claims:

1. A metal ion electrolyte composition, comprising:
at least one electrolyte salt of a metal selected from the group consisting of an alkali metal, an alkaline earth metal, zinc, and aluminum;
at least one solvent which solubilizes the at least one electrolyte salt; and
up to 25 wt. % of at least one non-polar additive;
wherein
the at least one solvent which solubilizes the at least one electrolyte salt is selected from the group consisting of cyclic sulfones, cyclic sultones, cyclic ethers, partially fluorinated sulfonamides, fluorinated solvents, and glymes,
the at least one nonpolar additive is selected from the group consisting of aromatic hydrocarbons, partially fluorinated aromatic hydrocarbons, fluorinated monoethers, partly fluorinated polyethers, fluorinated phosphate esters and fluorinated linear sulfones, and
a coulombic efficiency of the electrolyte composition with respect to plating and stripping of the metal is at least 90%.

2. The metal ion electrolyte composition according to claim 1, wherein the at least one solvent comprises a cyclic sulfone or a cyclic sultone which is selected from the group consisting of thietane-1,1-dioxide, 1,3-propane sultone and sulfolane.

3. The metal ion electrolyte composition according to claim 1, wherein the at least one solvent comprises a cyclic sulfone and a partially fluorinated sulfonamide.

4. The metal ion electrolyte composition according to claim 1, wherein the at least one solvent comprises a cyclic sulfone and a fluorinated solvent.

5. The metal ion electrolyte composition according to claim 1, wherein the at least one electrolyte salt selected from the group consisting of an alkali metal, an alkaline earth metal, zinc, and aluminum is a salt of an alkali metal.

6. The metal ion electrolyte composition according to claim 5, wherein the alkali metal is lithium and the at least one electrolyte salt is selected from the group consisting of lithium bis(trifluoromethanesulfonyl)imide, lithium bis(fluorosulfonyl)imide, lithium bis(oxalato)borate, lithium hexafluorophosphate, lithium hexafluoroarsenate, lithium tetrafluoroborate, lithium tetracyanoborate, lithium perchlorate, lithium tris((trifluoromethanesulfonyl) methanide, and lithium tetrafluorooxalatophosphate.

7. The metal ion electrolyte composition according to claim 6, wherein a concentration of the at least one electrolyte salt is from 0.001 molal to 16 molal.

8. The metal ion electrolyte composition according to claim 6, wherein the at least one solvent comprises a cyclic sulfone and a partially fluorinated sulfonamide.

9. The metal ion electrolyte composition according to claim 6, wherein the at least one solvent comprises a cyclic sulfone and a fluorinated solvent.

10. The metal ion electrolyte composition according to claim 9, wherein the at least one solvent comprises a cyclic sulfone and from 2 to 8 fluorinated solvents.

11. The metal ion electrolyte composition according to claim 9, wherein the fluorinated solvent is selected from the group consisting of 1-(2,6-dimethylphenyl)-2,2,2-trifluoroethanone, tris(2,2,2-trifluoroethyl) orthoformate, bis(2,2,2-trifluoroethyl) ether, 1,1,2,2-tetrafluoroethyl-2.2.3.3-tetrafluoropropylether, 4,4,6,6,7,7,9,9,10,10,12, 12-dodecafluoro-2,2,5,8,11,14-pentaoxapentadecane, 3,3,4,4,6,6,7,7,9,9,10,10-dodecafluoro-2, 2,5,8,11-tetraoxadodecane, and 2,2,3,3-tetrafluoro-1,4-dimethoxybutane.

12. The metal ion electrolyte composition according to claim 6, wherein the at least one electrolyte salt comprises from 2 to 5 electrolyte salts.

13. The metal ion electrolyte composition according to claim 6, wherein the at least one polar additive is toluene, and a content of the toluene is from 0.15 wt. % to 15 wt. %.

14. The metal ion electrolyte composition according to claim 8, wherein the partially fluorinated sulfonamide is 1,1,1-trifluoro-N,N-dimethylmethanesulfonamide, N-butyl-1,1, 1-trifluoro-N-methylmethanesulfonamide or a combination thereof.

15. The metal ion electrolyte composition according to claim 8, wherein the cyclic sulfone is thietane-1,1-dioxide, and the partially fluorinated sulfonamide is 1,1,1-trifluoro-N, N-dimethylmethanesulfonamide.

16. The metal ion electrolyte composition according to claim 1, wherein the at least one electrolyte salt of an alkali metal or alkaline earth metal is a salt of an alkaline earth metal.

17. The metal ion electrolyte composition according to claim 16, wherein the alkaline earth metal is magnesium and the at least one electrolyte salt is selected from the group consisting of [Mg₂Cl₃-6THF][HMDSAlCl₃], Mg[TFSI]₂, Mg(ClO₄)₂, Mg(BPh₂Bu)₂, Mg(AlCl₂BuEt)₂, Mg(HMDS)₂, Mg(BH₄)₂, MgB₁₂H₁₂, Mg(CB₁₁H₁₂)₂.

18. The metal ion electrolyte composition according to claim 17, wherein the at least one solvent is selected from the group consisting of cyclic ethers, fluorinated solvents and glymes.

19. The metal ion electrolyte composition according to claim 17, wherein a molar concentration of the at least one electrolyte salt is from 0.01 M to 0.5 M.

20. The metal ion electrolyte composition according to claim 17, wherein the at least one solvent comprises a glyme which is selected from the group consisting of monoglyme, diglyme, triglyme, and tetraglyme.

21. The metal ion electrolyte composition according to claim 17, wherein the at least one solvent comprises at least two glymes selected from the group consisting of monoglyme, diglyme, triglyme, and tetraglyme.

22. The metal ion electrolyte composition according to claim 17, wherein the at least one solvent comprises a cyclic ether selected from tetrahydrofuran and 1,3-dioxolane.

23. The metal ion electrolyte composition according to claim 17, wherein the at least one solvent comprises 1 or more fluorinated solvents selected from the group consisting of 1-(2,6-dimethylphenyl)-2,2,2-trifluoroethanone, tris(2,2,2-trifluoroethyl) orthoformate, bis(2,2,2-trifluoroethyl) ether, 1,1,2,2-tetrafluoroethyl-2,2,3,3-tetrafluoropropylether, 4,4,6,6,7,7,9,9,10,10,12,12-dodecafluoro-2,2,5,8,11,14-pentaoxapentadecane, 3,3,4,4,6,6,7,7,9,9,10,10-dodecafluoro-2,2,5,8,11-tetraoxadodecane, and 2,2,3,3-tetrafluoro-1,4-dimethoxybutane.

24. The metal ion electrolyte composition according to claim 17, wherein the at least one nonpolar additive is toluene.
